(19) United States
(12) Patent Application Publication
(10) Pub. No.: US 2014/0072469 A1
(43) Pub. Date: Mar. 13, 2014

(54) INERT HIGH HARDNESS MATERIAL FOR TOOL LENS PRODUCTION

(71) Applicants: Elizabeth Ann Binky Sargent, Latrobe, PA (US); Sudhir Brahmandam, Irwin, PA (US); Christopher D. Dunn, Greensburg, PA (US); Irene Spitsberg, Export, PA (US); Michael James Verti, Murrysville, PA (US); William Roy Huston, Traverse City, MI (US)

(72) Inventors: Elizabeth Ann Binky Sargent, Latrobe, PA (US); Sudhir Brahmandam, Irwin, PA (US); Christopher D. Dunn, Greensburg, PA (US); Irene Spitsberg, Export, PA (US); Michael James Verti, Murrysville, PA (US); William Roy Huston, Traverse City, MI (US)

(73) Assignee: Kennametal Inc., Latrobe, PA (US)

(21) Appl. No.: 13/607,899

(22) Filed: Sep. 10, 2012

(51) Int. Cl. B32B 15/02; B29C 33/00; B22F 3/12

(52) U.S. Cl. 419/18; 75/236

(57) ABSTRACT

In one aspect, tungsten carbide material systems are described herein which, in some embodiments, can provide desirable characteristics including chemical inertness, high hardness, reduced sensitivity to local compositional fluctuations and/or enhanced machining properties. In some embodiments, a tungsten carbide material described herein comprises 5.85-6.13 wt. % carbon, 0.85-1.05 wt. % chromium, less than 0.3 wt. % binder, less than 0.3 wt. % impurities and a balance being tungsten.

### FIELD

The present invention is directed to a densified inert material for use in glass molding processes, and more particularly, is a tungsten carbide material and a method of manufacturing thereof.

### BACKGROUND

Modern glass-making process requirements have placed a greater demand on the performance of materials used for glass-making molds. For instance, glass quality requirements are greater, process temperatures are higher, closer control of dimensional tolerances is desired, longer service life is expected and high productivity has become an economic necessity. All of these requirements have pushed the demands on the properties and performance of mold materials to increasingly higher levels. This is more prevalent in the precision glass making industry as the growth of the lens market in consumer electronics, for example camera phones and digital cameras, and industrial optics has shifted lens production from traditional diamond turning operations to high volume, low cost molding operations.

In addition to improving the quality of the mold material, which in turn improves the quality of the molded glass, increasing mold life is also desired. Examples of factors that affect both quality and mold life are the chemical inertness as well as the machinability of the mold material. In particular, precision glass lens producers report chemical interaction of the hot mold material with the molten glass during molding operations as being one of the primary causes of mold failure. The problem of a contaminant in the mold not only decreases mold life but also diminishes the optical quality of the glass or lens being produced.

Various solutions have been considered in the industry for addressing the problems of mold life, fabrication costs as well as quality of the molded glass. One solution includes the use of a high chemical purity silicon carbide material. While the chemical inertness and high hardness of silicon carbide make it a material of interest for precision glass molds, the brittle nature of silicon carbide can present handling and finishing concerns. Furthermore, silicon carbide is often an expensive material solution and therefore is not practical.

Another alternative may be the use of ceramics. The relative inertness and high hardness of ceramic materials, such as silicon nitrides, are beneficial for applications such as glass molding. However, final grinding and polishing can be time consuming and expensive due to the parameters required to obtain the required surface finish without chipping and/or breaking. More importantly, the co-efficient of thermal expansion in ceramic materials is significantly lower than that of the glass being molded and introduces mold design challenges.

Binderless tungsten carbide is further option. Binderless tungsten carbide has been discussed in the industry as a good fit for precision glass molding applications due to the high hardness and matching coefficient of thermal expansion of tungsten carbide. It is understood, however, that achieving full densification in the absence of a binder material presents a significant manufacturing challenge, leading this type of material to have porosity and other defects which in turn renders it unsuitable for finishing as well as subsequent usage for mold tooling.

Advances have been made in carbide mold materials addressing porosity and densification. However, microstructural defects or imperfections revealed during final polishing of a carbide mold material remain and increase costs to the manufacturing process in the form of reduced tooling yield and expenses related to rework. The machining of aspheric shapes in molds renders the molds relatively expensive, particularly since very hard and durable mold materials are generally required. In many cases, defects in the microstructure are induced by small, localized compositional variations in the mold material. Such compositional fluctuations can give rise to substoichiometric carbide phases and/or impurity phases resulting in defect formation.

To successfully address the functional requirements of precision glass molds and mitigate tooling yield loss from latent microstructural defects, materials demonstrating high hardness, chemical inertness and reduced sensitivity to localized compositional variations are required.

### SUMMARY

In one aspect, tungsten carbide material systems are described herein which, in some embodiments, can provide desirable characteristics including chemical inertness, high hardness, reduced sensitivity to local compositional fluctuations and/or enhanced machining properties. In some embodiments, a tungsten carbide material described herein comprises 5.85-6.13 wt. % carbon, 0.85-1.05 wt. % chromium, less than 0.3 wt. % binder, less than 0.3 wt. % impurities and a balance being tungsten. Tungsten carbide materials described herein, in some embodiments, have a nominal grain size of less than 0.5 μm. In one embodiment, for example, a tungsten carbide material has a nominal grain size of 0.25 to 0.4 μm. Further, in some embodiments, the binder is cobalt in an amount ranging from 0.15 to 0.25 wt. %.

In some embodiments, a tungsten carbide material described herein consists essentially of monotungsten carbide (WC). In one embodiment, for example, a tungsten carbide material described herein is free or substantially free of ditungsten carbide (W₂C). Additionally, the tungsten carbide material can have a density at least 98% of theoretical density and a void volume of less than 2%.

In another aspect, molds for precision glass molding applications are described herein. In some embodiments, a mold for precision glass molding comprises 5.85-6.13 wt. % carbon, 0.85-1.05 wt. % chromium, less than 0.3 wt. % binder, less than 0.3 wt. % impurities and a balance being tungsten. The mold, in some embodiments, has a nominal grain size of less than 0.5 um. Binder of the mold, in some embodiments, is cobalt in an amount ranging from 0.15 to 0.25 wt%. In some embodiments, the mold consists essentially of monotungsten carbide, wherein the mold demonstrates a density of at least 98% theoretical density and a void volume less than 2%. Further, in some embodiments, the mold is free or substantially free of W₂C.

In another aspect, methods of manufacturing articles for molding glass are described herein. In some embodiments, a method of manufacturing an article for molding glass comprises compacting a material, debindering the material and thermally densifying the material. The material, in some embodiments, comprises 5.85-6.13 wt. % carbon, 0.85-1.05 wt. % chromium, less than 0.3 wt. % binder, less than 0.3 wt. % impurities and a balance being tungsten. Thermally densifying the material, in some embodiments, comprises thermal sintering, pressure-assisted sintering, rapid omnidirectional compaction, microwave sintering or spark plasma sintering or combinations thereof.

Articles produced according to methods described herein can be a mold, blank, semi-finished component or the like. The article, in some embodiments, has a density of at least 98% theoretical and a void volume less than 2%.

These and other embodiments are described in greater detail in the detailed description which follows.

### BRIEF DESCRIPTION OF THE DRAWINGS

FIG. 1 illustrates a defect of a tungsten carbide mold material according to one embodiment.

FIG. 2 illustrates surface profilometry of a tungsten carbide material according to one embodiment described herein in comparison with a prior tungsten carbide material.

FIG. 3 illustrates normalized surface defects of a tungsten carbide material according to one embodiment described herein in comparison with a prior tungsten carbide material.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the scope of the invention.

It is also to be understood that the terminology used in the description is for the purpose of describing the particular versions or embodiments only, and is not intended to limit the scope. For example, as used herein and in the appended claims, the singular forms “a”, “an”, and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

In one aspect, tungsten carbide material systems are described herein which, in some embodiments, can provide desirable characteristics including chemical inertness, high hardness, reduced sensitivity to local compositional fluctuations and/or enhanced machining properties. In some embodiments, such tungsten carbide material systems are monotungsten carbide being free or substantially free of W₂C. For example, in some embodiments, tungsten carbide material systems described herein include carbon at or near stoichiometry, a low binder and impurity content and a substantially uniform and nominal grain size less than about 0.5 μm.

In some embodiments, a tungsten carbide material described herein comprises 5.85-6.13 wt. % carbon, 0.85-1.05 wt. % chromium, less than 0.3 wt. % binder, less than 0.3 wt. % impurities and a balance being tungsten. The tungsten carbide material, in some embodiments, has a nominal grain size less than 0.5 μm. In one embodiment, for example, the tungsten carbide material has a nominal grain size ranging from 0.25 μm to 0.4 μm. Additionally, in some embodiments, the tungsten carbide material can have a density at least 98% of theoretical density and a void volume of less than 2%. In some embodiments, the tungsten carbide material is at least 99% percent theoretical density. Further, the tungsten carbide material, in some embodiments, is fully dense (>99% theoretical density).

As described herein, a tungsten carbide material comprises 5.85-6.13 wt. % carbon. In some embodiments, the tungsten carbide material comprises 5.92-6.04 wt % carbon. The carbon level in conjunction with chromium of the material, in some embodiments, is sufficient to preclude or inhibit the formation of W₂C and η-phases as well as lower than full carbon saturation. Additionally, the upper limit of the carbon content is controlled to allow for the desired single-phase material, monotungsten carbide, without the formation of carbon porosity.

Ditungsten carbide is not desired in the material as it is more reactive than monotungsten carbide in acid and oxidizing atmospheres. Additionally, the coefficient of thermal expansion of monotungsten carbide is more isotropic than that of ditungsten carbide, making it a more desirable phase for dimensional consistency in applications such as glass molding operations. Further, the two phases (i.e. WC and W₂C) have different hardnesses and therefore present problems if coexistent in a surface requiring nanometer finishes. The tungsten carbide material herein, in some embodiments, is monotungsten carbide with less than 2% being of a phase with substoichiometric carbon. In some embodiments, the tungsten carbide material herein is monotungsten carbide with less than 1% being of a phase with substoichiometric carbon.

The tungsten carbide material also comprises chromium in an amount of 0.85-1.05 wt. %. When forming the tungsten carbide material, as discussed further herein, chromium can be provided as chromium carbide, such as Cr₃C₂. In such embodiments, the target carbon range described herein of the tungsten carbide material is maintained. In some embodiments, a combination of chromium and carbon level is provided in the tungsten carbide material sufficient to inhibit or preclude the formation of W₂C and η-phases as well as lower than full carbon saturation. Additionally, in some embodiments, the tungsten carbide material does not comprise grain growth inhibitor of vanadium carbide, niobium carbide, zirconium-niobium carbide, titanium carbide, tantalum carbide or combinations thereof.

The tungsten carbide material can also comprise less than 0.3 wt. % total binder. The binder promotes or aids in the full densification of the tungsten carbide material and is relatively inert to the glass being molded. By producing a denser material, the porosity of the material is decreased, thereby allowing for better machinability which in turn allows for a nanometer level surface finish of the material. The upper limit is established to reduce the chemical potential so as to eliminate or substantially decrease, such as decresase by 90%, diffusion of the material into the glass. Examples of binder materials include cobalt, iron and/or nickel. In some embodiments, the binder material may be relatively inert to the glass being molded.

In some embodiments, for example, the binder material is cobalt. Cobalt binder, in one embodiment, is present in the tungsten carbide material in an amount of 0.05-0.3 wt. %. In another embodiment, cobalt binder is present in an amount of 0.1-0.25 wt. %. In further embodiments, cobalt is present in the tungsten carbide material in an amount of 0.15-0.25 wt. %. In some embodiments, the binder is cobalt and iron or cobalt and nickel.

In some embodiments, the total impurity level of the tungsten carbide material, including for example, iron, is less than 0.60 wt. %. In some embodiments, the total impurity level is 0.10-0.60 wt. %. In addition to iron, impurities include but are not limited to titanium, tantalum, copper, molybdenum and/or nickel. By controlling the amount of impurities, uniform phase compositions can be achieved and thermodynamic instabilities that can lead to the formation of porosity are reduced. As iron has higher chemical activity than cobalt, the amount of iron that may cause contamination of the glass is much smaller than an amount of cobalt to cause a comparable effect. Iron and other unintentional chemical components are also minimized to preclude the formation of additional phases in the finished microstructure. In some embodiments, iron is present in the tungsten carbide material in an amount less than 0.3 wt %. In one embodiment, for example, iron is present in an amount of 0.05-0.2 wt. %.

In addition to controlling the impurities of the material to a low level, uniform microstructure across the surface and controlled grain size are desirable for machinability. The tungsten carbide material, in some embodiments, has a nominal grain size of 0.5 μm or less, such as less than 0.4 μm, such as 0.28-0.31 μm as measured by a linear intercept method on fracture surface at 20,000× magnification. Microstructural inconsistencies result in profilometry deviations on a polished surface. A very small grain size provides a more uniform polished surface and less chance of variances due to single grain pull out.

The tungsten carbide material, in some embodiments, demonstrates a Vickers hardness of at least about 2500 (1 kg. load). In some embodiments, the tungsten carbide material demonstrates a Vickers hardness ranging from 2500 to 3000 (1 kg. load). The hardness of the material is preferably high as it is an important factor in achieving nanometer surface finishes, for example, when used in glass molding operations. The material hardness, in some embodiments, is uniform across the surface such that the rate of material removal is consistent during grinding, as localized areas of softer material, for example, due to composition, phase or defects, will relief polish. Conversely, localized areas of harder material may result in peaks in the surface profile when material removal is less than in surrounding areas. Thus, the hardness of a material is a function of composition, grain size, and processing.

The tungsten carbide material described herein, in some embodiments, is free or substantially free of porosity and/or defects observable through optical microscopy. In some embodiments, for example, the tungsten carbide material has no pores and/or anomalous microstructural features or defects larger than 0.5 μm in size. In one embodiment, the tungsten carbide material has a void volume of less than 2%.

The tungsten carbide material described herein can have a density of at least about 98% theoretical or at least about 98.5% theoretical. In some embodiments, the tungsten carbide material has a density at least about 99% theoretical. The theoretical density of monotungsten carbide is 15.7 g/cm³. The theoretical density of the tungsten carbide material described herein, in some embodiments, varies from about 15.43 to about 15.50 g/cm³, such as 15.47 g/cm³.

The tungsten carbide material described herein, in some embodiments, is inert as measured by inertness testing and observation of surface reactivity. Additionally, the inert tungsten carbide material when observed by optical metallography, can have less than two occurrences of substoichiometric tungsten carbide, such as W₂C, per 3000 mm² of view at 200× magnification. Further, as measured by x-ray diffraction, the tungsten carbide material, in some embodiments, has no more than 2% of substoichiometric tungsten carbide. In some embodiments, the tungsten carbide material has no more than 1% substoichiometric tungsten carbide.

The machinability of the tungsten carbide material is measured through metallographic examination and surface profilometry after machining The metallographic examination of the tungsten carbide material described herein results in, for example, less than 3 defects normalized to a 3000 mm² surface area of the tungsten carbide material. In some embodiments, the metallographic examination results in less than 2 defects normalized to a 3000 mm² surface area of the tungsten carbide material. Further, in some embodiments, the metallographic examination demonstrates no defects normalized to a 3000 mm² surface area of the machined tungsten carbide material.

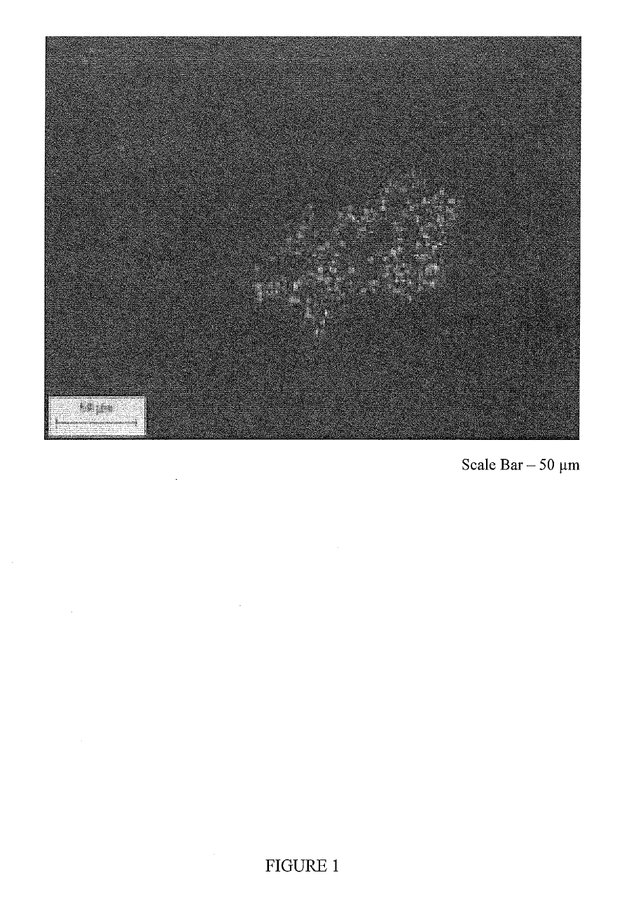

Defects include substoichiometric tungsten carbide structure(s) and/or impurity structure(s) having a size of at least 5 μm. Substoichiometric tungsten carbide of a defect, in some embodiments, is W₂C. In some embodiments, a defect is formed of closely spaced regions of substoichiometric tungsten carbide and/or impurities that, in the aggregate, provide a structure or region having a size of at least 5 μm. FIG. 1 illustrates a defect of a tungsten carbide mold material according to one embodiment. As illustrated in FIG. 1, the defect is formed of closely spaced regions of substoichiometric tungsten carbide.

Additionally, the profilometry profile of the tungsten carbide material, in some embodiments, has a Rₐ of less than 1.4 nm or less than 1.3 nm. The profilometry profile of the tungsten carbide material can also demonstrate a R_{q} less than 1.6, such as a R_{q} of about 1.5.

The tungsten carbide material described herein can be used in a number of applications. An example of an application is the use of the tungsten carbide material as tooling for molding precision glass lenses. Glass molding temperatures for example may vary with the type of glass being molded. The tungsten carbide material described herein has the ability to withstand a working temperature of at least 650° C. and can provide oxidation resistance under molding conditions of vacuum or inert gas at such temperatures.

Accordingly, molds comprising the tungsten carbide material described herein are provided. In some embodiments, for example, a mold for precision glass molding comprises 5.85-6.13 wt. % carbon, 0.85-1.05 wt. % chromium, less than 0.3 wt. % binder, less than 0.3 wt. % impurities and a balance being tungsten.

The tungsten carbide material of a mold for precision glass molding can have any compositional, chemical and/or physical properties described hereinabove for a tungsten carbide material. The mold, in some embodiments, has a nominal grain size of less than 0.5 um. Binder of the mold, in some embodiments, is cobalt in an amount ranging from 0.15 to 0.25 wt %. In some embodiments, the mold consists essentially of monotungsten carbide, wherein the mold demonstrates a density of at least 98% theoretical density and a void volume less than 2%. In some embodiments, for example, the mold is free or substantially free of W₂C. The mold can also demonstrate any profilometry profile described hereinabove, including the values provided for Rₐ, R_{q} and/or defect occurrence.

In some embodiments, the tungsten carbide mold may further include a coating on an inner surface. Examples of such coating layers include but are not limited to diamond-like carbon, TiCN, A1TiN, NiAl and the like.

In another aspect, methods of manufacturing articles for molding glass are described herein. In some embodiments, a method of manufacturing an article for molding glass comprises compacting a material, debindering the material and thermally densifying the material. The material, in some embodiments, comprises 5.85-6.13 wt. % carbon, 0.85-1.05 wt. % chromium, less than 0.3 wt. % binder, less than 0.3 wt. % impurities and a balance being tungsten. Thermally densifying the material, in some embodiments, comprises thermal sintering, pressure-assisted sintering, rapid omnidirectional compaction, microwave sintering or spark plasma sintering or combinations thereof.

Turning now to specific steps, a method described herein comprises preparing a powder composition of 0.85-1.05 wt. % chromium, less than 0.3 wt. % binder, less than 0.3 wt. % impurities and the balance monotungsten carbide. In some embodiments, chromium is provided as a carbide, wherein the amount of chromium carbide and monotungsten carbide in the powder composition satisfies the desired carbon range of 5.85-6.13 wt. %. The powder composition, in some embodiments, has a nominal particle size of about 0.4 μm.

The powder composition is then consolidated or compacted into a preform, near net shape, slug forms or the like. Compaction may be performed by using direct, in-direct and/or super-high pressure pressing methods. Other examples of compaction may include uniaxial pressing, multi-platen pressing, dry bag isostatic pressing, cold isostatic pressing and/or super high pressure (SHP) compaction.

A step of removing a binder or debindering the preform is administered. Debindering can include microwave sintering and spark plasma sintering to remove organic binders and densify the material. Binder removal usually entails heating the compact preform from ambient temperature to a temperature sufficient to pyrolyze the highest molecular weight component. If a polyolefin, for example, is used as part of the binder formulation, the temperature sufficient to pyrolyze the highest molecular weight component commonly occurs from 500° C. to about 600° C. An especially suitable temperature for the burn-out step may be about 750° C. to about 900° C., which is the temperature at which the reduction of carbon by oxidation can take place and carbon monoxide and/or carbon dioxide may be evolved. Binder burn-out processes may be performed in vacuum or in any inert atmosphere. Alternatively or subsequent to binder burn-out, the compacted product may be debindered using chemical methods.

After debindering operations, the debindered preform undergoes a thermal densification step. The step may include pre-sintering, green machining, reisopressing and the like. For example, the preform may be sintered at elevated temperatures by pressure-assisted or pressureless techniques. Typical sintering temperatures for tungsten carbide are from about 1300° C. to about 1850° C., more typically, from about 1600° C. to about 1700° C. A temperature hold between 800° C. and 1200° C. can be administered either in the debindering step or in the sintering step to allow the release of carbon monoxide and/or carbon dioxide before it is trapped in the material by densification. In some embodiments, the preform is subjected to pressureless sintering techniques, which are sintering techniques performed at or below atmospheric pressure. The sintering atmosphere may be, for example, inert gas, such as argon.

Depending on additives and the sintering temperatures employed, the sintering may be liquid-phase sintering or non-liquid-phase sintering. Liquid-phase sintering is sintering which occurs at a temperature at or above the liquidus temperature of the material being densified or any added materials, such as “sintering aids” (which are added to enhance sinterability). Non-liquid-phase sintering is sintering which occurs at a temperature below the liquidus temperature of all of the components of the material being densified. Usually, with tungsten carbide and pressureless sintering techniques, non-liquid phase sintering is employed.

Other examples of achieving densification include thermal processes such as vacuum sintering, process gas sintering, pressure sintering, Rapid Omni-directional Compaction, microwave sintering and/or spark plasma sintering.

The method may further include steps of hot isostatic pressing (HIP). In alternate embodiments, grinding may be performed on blanks prior to semi-finish and finishing operations. After such operations, profilometry may be used to assess the surface roughness after grinding and polishing of the sintered article. In some embodiments, for example, the sintered article can demonstrate any profilometry profile described hereinabove, including the values provided for Rₐ, R_{q} and/or defect occurrence. Further, the sintered tungsten carbide material forming the article can have any compositional, chemical and/or physical properties recited hereinabove for the tungsten carbide material.

The compacted article may be a mold, blank, semi-finished or finished article. Another embodiment includes a method of forming a blank, semi-finished or finished tungsten carbide mold. Other embodiments include single cavity or multicavity arrays.

These and other embodiments are further illustrated in the following non-limiting examples.

### EXAMPLES

TABLE 1

| | Comparative | Inventive |
|---|---|---|
| | WC—0.12% Co—0.3% VC | WC—0.16% Co—0.95% Cr |
| Carbon | 6.06-6.13% | 5.85-6.13% |
| RMS | 1.84 nm | 1.54 nm |
| Hardness | 2500-2750 | 2650-2900 |
| HVN | | |
| Grain Size | <0.5 μm | <0.5 μm |

Table 1 sets forth compositions (in wt. %) and several properties of a comparative tungsten carbide material and an inventive tungsten carbide material according to one non-limiting embodiment described herein. Rods of each tungsten carbide material (Comparative and Inventive) were prepared by debindering and thermal densification by Rapid Omni-directional Compaction. Sections were cut from each rod, ground and polished. The grinding and polishing parameters were as follows:

### Grinding Wheel Specification

### Diameter—20 mm

Shape—conic, 30° angle
Bonding—resin
Abrasives—diamonds, concentration 150, mesh 1500/3000

### Range of Parameters

Depth of cut—0.1 to 2.0 μm
Feed rate—0.1 to 2.0 mm/min
Cutting velocity—15 to 30 m/s
Grit size—#1500, #3000
Final lapping was conducted using a 0.3 μm diamond paste.

At least 3,000 mm² of machined surface area were analyzed for each of the Comparative and Inventive tungsten carbide materials using optical microscopy at 200× magnification. The microstructural uniformity, as measured by metallographic examination and surface profilometry after machining, was obtained for each sample.

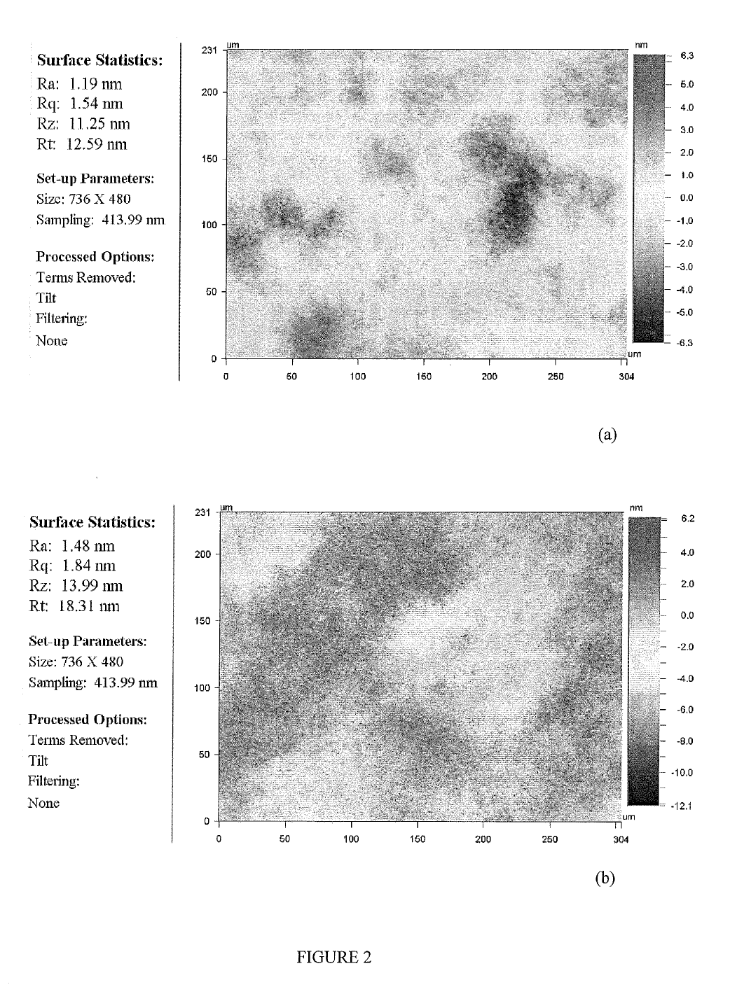

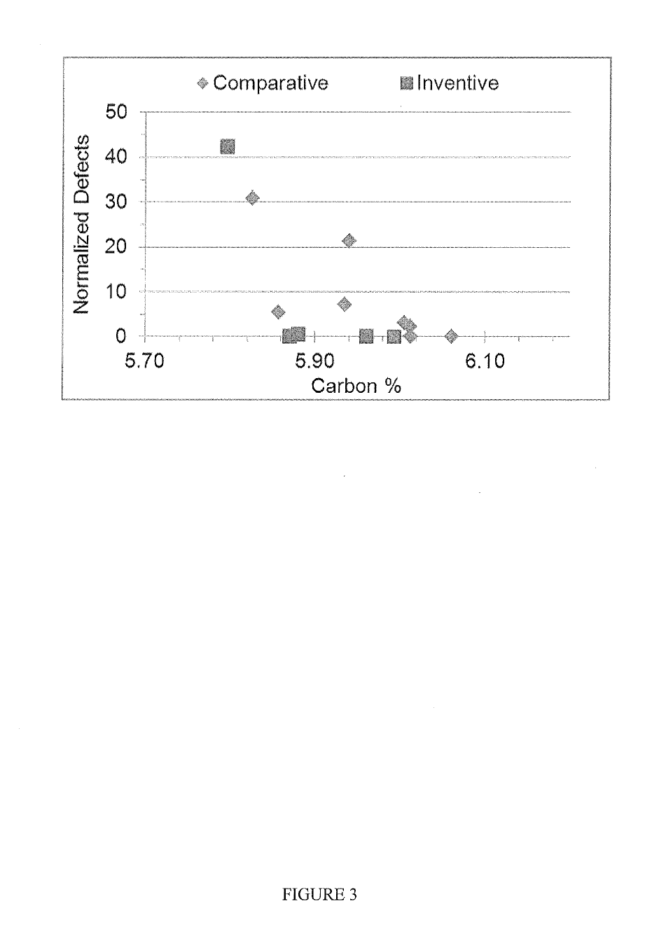

FIG. 2 illustrates surface profilometry of the Inventive tungsten carbide material according to the present embodiment and the Comparative tungsten carbide material. The Inventive tungsten carbide material of FIG. 2(a) demonstrated more uniform surface characteristics than the Comparative tungsten carbide material of FIG. 2(b). Further, FIG. 3 illustrates occurrences of surface defects of the Inventive tungsten carbide material and the Comparative material. The number of defects for each tungsten carbide material was normalized to the 3,000 mm² of surface area analyzed. As illustrated in FIG. 3, the Inventive tungsten carbide material displayed a significantly lower occurrence of defects over a broader carbon range than the Comparative material. As a result, the Inventive tungsten carbide material is operable to better tolerate local compositional fluctuations without producing associated defects that can increase evaluation and qualification time of the tungsten carbide material for precision glass molding operations.

Various embodiments of the invention have been described in fulfillment of the various objects of the invention. It should be recognized that these embodiments are merely illustrative of the principles of the present invention. Numerous modifications and adaptations will be readily apparent to those skilled in the art without departing from the spirit and scope of the invention.

1. A tungsten carbide material comprising:
0.85-1.05 wt % chromium;
5.85-6.13 wt % carbon;
0-0.3 wt % binder; and
less than 0.3 wt % total impurities.

2. The tungsten carbide material of claim 1, wherein the binder is present in an amount of 0.15 to 0.25 wt. %.

3. The tungsten carbide material of claim 2, wherein the binder is cobalt.

4. The tungsten carbide material of claim 1 comprising from 5.92 to 6.04 wt. % carbon.

5. The tungsten carbide material of claim 1, wherein the tungsten carbide material is free or substantially free of substoichiometric tungsten carbide.

6. The tungsten carbide material of claim 5, wherein the substoichiometric tungsten carbide comprises ditungsten carbide.

7. The tungsten carbide material of claim 1, wherein the tungsten carbide is mono-tungsten carbide.

8. The tungsten carbide material of claim 1, wherein the nominal grain size is from 0.25 to 0.5 μm.

9. The tungsten carbide material of claim 1, wherein the tungsten carbide material is a mold used in precision glass molding.

10. The tungsten carbide material of claim 1 having a density of at least 98% of theoretical density and a void volume of less than 2%.

11. A mold for precision glass molding comprising:
0.85-1.05 wt % chromium;
5.85-6.13 wt % carbon
0-0.3 wt % binder
less than 0.3 wt % total impurities; and
a balance being tungsten, wherein the mold has a nominal grain size of less than 0.5 μm.

12. The mold of claim 11, wherein the nominal grain size is from 0.25 to 0.4 μm.

13. The mold of claim 11, wherein the binder is present in an amount of 0.15 to 0.25 wt. %.

14. The mold of claim 13, wherein the binder is cobalt.

15. The mold of claim 11, wherein the mold comprises from 5.92 to 6.04 wt. % carbon.

16. The mold of claim 11 having a density of at least 98% of theoretical density and a void volume of less than 2%.

17. A method of manufacturing an article for molding glass comprising:
compacting a material;
debindering the material; and
thermally densifying the material, the material comprising, 0.85-1.05 wt % chromium, 5.85-6.13 wt % carbon, 0-0.3 wt % binder, less than 0.3 wt. % total impurities and a balance being tungsten.

18. The method of claim 17, wherein the densified material has a nominal grain size of less than 0.5 microns.

19. The method of claim 17, further comprising machining the material after thermally densifying the material.

20. The method of claim 17, wherein the material comprises from 5.92 to 6.04 wt. % carbon.

21. The method of claim 17, wherein the binder is present in an amount of 0.15 to 0.25 wt. %.

22. The mold of claim 21, wherein the binder is cobalt.

23. The method of claim 17, wherein thermally densifying comprises thermal sintering, pressure assisted sinter (HIP), rapid omnidirectional compaction, microwave sintering or spark plasma sintering or combinations thereof.

24. The method of claim 22, wherein the article is selected from the group consisting of a mold, a blank, a semi-finished or a finished component.
